(19) United States
(12) Patent Application Publication
(10) Pub. No.: US 2010/0328971 A1
(43) Pub. Date: Dec. 30, 2010

(54) BOUNDARY MODE COUPLED INDUCTOR BOOST POWER CONVERTER

(75) Inventors: George Rasko, San Jose, CA (US); Ernest H. Wittenbreder, JR., Flagstaff, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ASIC Advantage Inc., Sunnyvale, CA (US)

(21) Appl. No.: 12/824,301

(22) Filed: Jun. 28, 2010

Related U.S. Application Data
(60) Provisional application No. 61/221,049, filed on Jun. 27, 2009.
(60) Provisional application No. 61/221,050, filed on Jun. 27, 2009.

(51) Int. Cl. H02M 3/335

(52) U.S. Cl. 363/21.09

(57) ABSTRACT

Methods, systems, and devices are described for using coupled inductor boost circuits to operate in a zero current switching (ZCS) and/or a zero voltage switching (ZVS) boundary mode. Some embodiments include a coupled inductor boost circuit that can substantially eliminate rectifier reverse recovery effects without using a high side primary switch and a high side primary switch driver. Other embodiments include a coupled inductor boost circuit that can achieve substantially zero voltage switching. ZCS and ZVS modes may be effectuated using control techniques. For example, a magnetizing current may be sensed or otherwise represented, and a signal may be generated accordingly for controlling switching of the controller.

### CROSS-REFERENCES

This applications claims priority from co-pending U.S. Provisional Patent Application No. 61/221,049, filed Jun. 27, 2009, entitled “ZERO VOLTAGE SWITCHING BOUNDARY MODE COUPLED INDUCTOR BOOST POWER CONVERTERS”, and co-pending U.S. Provisional Patent Application No. 61/221,050, filed Jun. 27, 2009, entitled “BOUNDARY MODE COUPLED INDUCTOR BOOST POWER CONVERTERS”, which are hereby incorporated by reference, as if set forth in full in this document, for all purposes.

### FIELD

Embodiments generally pertain to electronic power conversion circuits, and, more specifically, to high frequency, switched mode electronic power converters.

### BACKGROUND

Many typical power converter applications convert power simply and efficiently at low and medium power levels using flyback converters. While other converter topologies are available, they may often be overlooked. For example, except in some limited housekeeping power supplies, coupled inductor boost converters may not be used in a wide variety of applications.

An embodiment of a typical coupled inductor boost converter circuit 100a is shown in FIG. 1A. Wave forms descriptive of the FIG. 1A circuit topology are illustrated in FIGS. 2A-2G. In the coupled inductor boost converter, by transferring energy out of the secondary winding during both on state and off state of the main primary switch, the secondary winding currents are reduced and the voltage stress of both secondary winding and secondary switches is reduced in comparison to those same quantities in a conventional flyback power converter.

While coupled inductor boost topologies are not common in many applications, depending on the line voltage range, many power conversion solutions that currently use flyback converters could be accomplished more efficiently with a smaller transformer using the coupled boost topology. In many applications the cost of the additional capacitor and switch required in the coupled boost circuit may be more than offset by the lower cost of the transformer and the fact that clamping leakage inductance ringing may be easier to accomplish and may require fewer components in the coupled boost circuit.

As illustrated by FIG. 1A, a first terminal of an input source 110 of direct current (DC) power and voltage (V_{LINE}) is connected to a dotted terminal of a primary winding of a coupled inductor 105. A second terminal of the input source 110 is connected to a first terminal of a first switch 120a. A second terminal of switch 120a is connected to an undotted terminal of the primary winding of coupled inductor 105. An undotted terminal of a secondary winding of coupled inductor 105 is connected to a first terminal of a capacitor 115a and to a first terminal of a capacitor 115b. A dotted terminal of a secondary winding of coupled inductor 105 is connected to a first terminal of a second switch 120b and to a first terminal of a third switch 120c. A second terminal of switch 120b is connected to a first terminal of a load 150 and to a second terminal of capacitor 115a. A second terminal of switch 120c is connected to a second terminal of capacitor 115b and to a second terminal of load 150. As used herein, the terminals of the “load” 150 may be generally construed (e.g., and also referred to) as terminals of the “output.”

In operation, the circuit 100a has two operating states with dead times between operating states which may be brief by comparison to the duration of the operating states. These operating modes are illustrated by FIGS. 1B and 1C. For the sake of clarity, the following conditions are assumed: the circuit 100a has reached a steady state condition; the capacitors 115 are sufficiently large that the capacitor 115 voltages are invariant over a single operating cycle; there is a substantial amount of mutual magnetic coupling between the primary and secondary windings of the coupled inductor 105, and that the leakage inductance is small and has only a small effect on circuit current and voltage wave forms; and the design of the coupled inductor 105 follows the design of a flyback transformer in that the coupled inductor 105 serves as both a magnetic energy storage device and as a way of stepping up or stepping down voltages and currents through the ratio of primary to secondary winding turns. This last assumption may suggest the existence of a discrete or distributed gap in the core structure of the coupled inductor 105 or a core structure composed of a magnetic material with a magnetic permeability less than the permeability of typical ferrite power materials used in switched mode power supplies, an example of which is the Ferroxcube 3C80 material.

During a first operating state, illustrated in FIG. 1B as partial circuit 100b, switches 120a and 120b are ON (conducting) and switch 120c is OFF (non-conducting). It will be appreciated that this first operating mode is illustrated in various portions (substantially the first half of each period of each wave form) shown in FIGS. 2A-2G. Current flows in a primary loop including the input source 110, the primary winding of coupled inductor 105, and switch 120a. Current also flows clockwise in a first secondary loop comprising capacitor 115a, switch 120b, and the secondary winding of coupled inductor 105, and clockwise in a second secondary loop comprising capacitors 115a and 115b, and the load 150.

During this first operating state, current ramps up in the primary loop, as illustrated in FIG. 2B. The rate of current rise in the primary loop may be dependent on the value of magnetizing inductance of coupled inductor 105 and the source voltage applied to the magnetizing inductance. The current in the primary loop during the ON time of switch 120a has two components, a magnetizing current component and a reflected secondary current component. The reflected secondary current component of the primary current may be substantially equal to the secondary winding current multiplied by the secondary to primary turns ratio of the coupled inductor 105. During the first operating state, capacitor 115a is charged and capacitor 115b is discharged.

FIG. 1C illustrates a second operating state (as partial circuit 100c) in which the switches 120a and 120b are OFF and the switch 120c is ON. It will be appreciated that this second operating mode is illustrated in various portions (substantially the second half of each period of each wave form) shown in FIGS. 2A-2G. During the second operating state, coupled inductor 105, the switch 120c, and the capacitor 115b behave substantially as a flyback converter secondary circuit. For example, during the second operating state, the magnetizing current flows in the secondary winding and switch 120c and ramps down, as illustrated in FIGS. 2F and 2G. During the second operating state, the capacitor 115b is charged and the capacitor 115a is discharged into the load.

Notably, in a typical coupled inductor boost converter, like the one illustrated by the circuit 100a of FIG. 1A, the magnetizing current is always significantly positive. For example, as illustrated in FIG. 2G, the coupled inductor boost converter is operating in a continuous mode. The magnetizing current (I_{MAG}) periodically ramps up and ramps down, but does not approach zero current during operation.

### BRIEF SUMMARY

Among other things, novel coupled inductor boost circuits are provided that operate in a zero current switching (ZCS) boundary mode and/or a zero voltage switching (ZVS) boundary mode. Some embodiments include a coupled inductor boost circuit that can substantially eliminate rectifier reverse recovery effects without using a high side primary switch and a high side primary switch driver. Other embodiments include a coupled inductor boost circuit that can achieve substantially zero voltage switching.

According to some embodiments, ZCS and ZVS modes are effectuated using control techniques. In certain embodiments, magnetizing current is sensed, and a control signal is generated accordingly. In other embodiments, a representation of the magnetizing current is generated, and the control signal is generated accordingly. The control signal may then be used to control (e.g., affect switching of) the primary power side of the coupled inductor. The control signal may also be used to directly or indirectly control (e.g., affect switching of) the secondary power side of the coupled inductor.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a second label (e.g., a lower-case letter) that distinguishes among the similar components. If only the first reference label is used in the specification, the description is applicable to any one of the similar components having the same first reference label irrespective of the second reference label.

FIG. 1A shows an embodiment of a prior art coupled inductor boost converter circuit.

FIG. 1B shows an embodiment of a prior art first operating state of the converter of FIG. 1A.

FIG. 1C shows an embodiment of a prior art second operating state of the converter of FIG. 1A.

FIGS. 2A-2G show embodiments of prior art illustrative wave forms descriptive of the FIG. 1A circuit topology.

FIG. 3A shows a simplified block diagram of an illustrative coupled inductor boost power converter, according to various embodiments.

FIG. 3B shows a simplified block diagram of another illustrative coupled inductor boost power converter, according to various embodiments.

FIG. 4, a schematic diagram is shown of an illustrative ZCS-mode coupled inductor boost power converter, according to various embodiments.

FIGS. 5A-5G show illustrative wave forms describing the functionality of the ZCS-mode coupled inductor boost power converter of FIG. 4.

FIG. 6 shows a schematic diagram of an illustrative ZVS-mode coupled inductor boost power converter 600, according to various embodiments.

FIGS. 7A-7G show illustrative wave forms describing the functionality of the ZVS-mode coupled inductor boost power converter of FIG. 6.

FIG. 8 shows a schematic diagram of an illustrative coupled inductor boost power converter, according to various embodiments.

FIG. 9 shows a schematic diagram of another illustrative coupled inductor boost power converter that is similar to the converter of FIG. 8, but with secondary side switches implemented as pairs of switches in a full bridge rectifier arrangement, according to various embodiments.

FIG. 10 shows a schematic diagram of an illustrative tapped inductor boost power converter, according to various embodiments.

FIG. 11 shows a schematic diagram of another illustrative tapped inductor boost power converter that is similar to the converter of FIG. 10, except that the first load terminal connects to the second input source terminal, according to various embodiments.

FIG. 12 shows a schematic diagram of yet another illustrative tapped inductor boost power converter that is similar to the converter of FIG. 10, configured to allow the load voltage to be larger than the line voltage except that the first load terminal connects to the second input source terminal, according to various embodiments.

FIG. 13 shows a schematic diagram of still another illustrative tapped inductor boost power converter that is similar to the converter of FIG. 10, except that certain switches are implemented using MOSFETs, according to various embodiments.

FIG. 14 shows a schematic diagram of even another illustrative tapped inductor boost power converter that is similar to the converter of FIG. 10, except that all switches are implemented using MOSFETs, according to various embodiments.

FIG. 15 shows a schematic diagram of another illustrative tapped inductor boost power converter that is similar to the converter of FIG. 10, except that the second terminal of the load is connected to the first terminal of the input source (according to the conventions discussed with reference to FIG. 10), according to various embodiments.

FIG. 16 shows a schematic diagram of yet another illustrative tapped inductor boost power converter that is similar to the converter of FIG. 15, except that the second terminal of the load is connected to the second terminal of the input source (e.g., according to the conventions discussed with reference to FIG. 10), according to various embodiments.

FIG. 17 shows a schematic diagram of another illustrative tapped inductor boost power converter that is similar to the converter of FIG. 15, except that the load shares a reference voltage (e.g., ground) with the input source and the main switch, according to various embodiments.

FIG. 18 shows a schematic diagram of an illustrative tapped inductor boost power converter that is similar to the converter of FIG. 17, except that a diode capacitance multiplier rectifier network is used to multiply the output load voltage, according to various embodiments.

FIG. 19 shows a flow diagram of an illustrative method for using a coupled inductor boost power converter in ZCS and/or ZVS mode, according to various embodiments.

### DETAILED DESCRIPTION

Embodiments are described herein for providing novel coupled inductor boost circuits that operate in a zero current switching (ZCS) boundary mode and/or a zero voltage switching (ZVS) boundary mode. For example, embodiments manifest improved functionality over typical flyback controller topologies for certain applications, such as in circuit applications where isolation may not be a requirement. Some embodiments include a coupled inductor boost circuit that can substantially eliminate rectifier reverse recovery effects without using a high side primary switch and a high side primary switch driver.

Other embodiments include a coupled inductor boost circuit that can achieve substantially zero current and/or zero voltage switching. For example, ZCS may be achieved by using a magnetizing inductance sufficiently small that the magnetizing current can drop to zero each cycle. Alternatively, ZVS may be achieved by using a magnetizing inductance sufficiently small that the magnetizing current can reverse each cycle. Since the magnetizing current is only a fraction of the total winding current, the associated conduction loss penalty may be small. Certain circuit embodiments include a single magnetic circuit element, one active line side switch, and two load side rectifiers.

According to some embodiments, ZCS and ZVS modes are effectuated using control techniques. In certain embodiments, magnetizing current is sensed, and a control signal is generated accordingly. In other embodiments, a representation of the magnetizing current is generated, and the control signal is generated accordingly. The control signal may then be used to control (e.g., affect switching of) the primary power side of the coupled inductor. The control signal may also be used to directly or indirectly control (e.g., affect switching of) the secondary power side of the coupled inductor.

As used herein, “connected” is intended to include conditions where there exists “a direct wire path for conduction of an electrical current between the two points of the circuit identified as being connected, without the existence of intervening circuit elements sufficiently large in impedance to alter the current or create a voltage difference between the two points that is not substantially zero”. Also, as used herein, the term “switch” is intended to be broadly construed as “an electrical circuit element that can have at least two electrical states, one of which substantially blocks current flow through the element and the other of which allows current flow through the element substantially unimpeded.” Examples of switches shall include, at a minimum, rectifier diodes, transistors, relays, and thyristors.

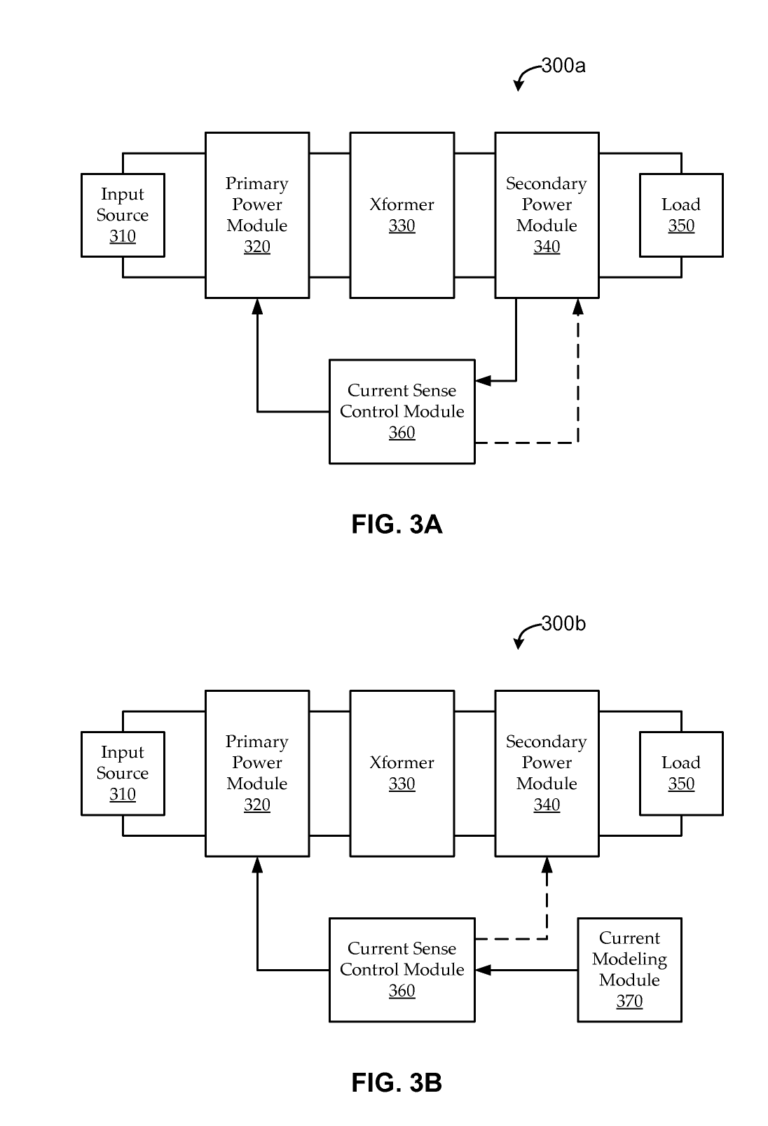

Turning first to FIG. 3A, a simplified block diagram is shown of an illustrative coupled inductor boost power converter 300a, according to various embodiments. The coupled inductor boost power converter 300a includes an input power source 310, a primary power module 320, a transformer 330, a secondary power module 340, a load 350, and a current sense control module 360. As described above with reference to prior art converters, the input power source 310 may be a source of DC power and voltage, the transformer 330 may be configured as a coupled inductor, and the load 350 may be any desired output load 350, depending on the application context.

The primary power module 320 may include one or more switches for driving a primary side of the transformer 330. The transformer 330 may transform the primary-side power from the primary power module 320 into secondary-side power, for example, by using primary-side current to induce a secondary-side current via the transformer 330. At the secondary side, the secondary power module 340 may be configured to deliver (e.g., process, convert, etc.) secondary-side power to the load 350.

In various embodiments, the magnetizing current of the transformer 330 (e.g., a secondary winding of the transformer 330) is sensed by the current sense control module 360. The current sense control module 360 may then generate a control signal for controlling the primary power module 320 and/or the secondary power module 340. For example, in a ZCS mode, the current sense control module 360 may switch the primary power module 320 according to when the secondary-side magnetizing current of the transformer 330 is at substantially zero (e.g., typically slightly positive, but near zero current). In a ZVS mode, the current sense control module 360 may switch the primary power module 320 according to when the secondary-side magnetizing current of the transformer 330 is sufficiently negative to provide energy for zero voltage switching.

The control switching may be used, in some embodiments, to directly control switching of the secondary power module 340, and thereby, output to the load 350. In some embodiments, however, the secondary power module 340 switching is configured to operate according to the state of the secondary side of the transformer 330. For example, the secondary power module 340 switches may switch according to the polarity of the secondary winding of the transformer 330. As such, in some embodiments, the control signal only indirectly affects the secondary power module 340 by directly affecting the primary power module 320.

It is worth noting that the current sensing (e.g., feedback) functionality of the current sense control module 360 may be implemented in other ways. FIG. 3B shows a simplified block diagram of another illustrative coupled inductor boost power converter 300b, according to various embodiments. The topology of the coupled inductor boost power converter 300b may be substantially identical to that of the coupled inductor boost power converter 300a of FIG. 3A, with the addition of a current modeling module 370.

In some applications, it may be desirable to avoid direct sensing of the transformer 330 magnetizing current. For example, it may be desirable to implement the current sense control module 360 on the primary side of the circuit (e.g., for isolation and/or other reasons), which may make direct sensing sub-optimal. As such, embodiments of the current modeling module 370 generate a representation of the magnetizing current.

For example, various techniques are known in the art for generating a current that substantially represents (e.g., tracks) the magnetizing current of the transformer 330. Embodiments use operational amplifiers and/or other elements to generate the representation. As in the coupled inductor boost power converter 300a of FIG. 3A, the representation can be fed into the current sense control module 360 and used to generate a control signal for controlling the primary power module 320 and/or the secondary power module 340.

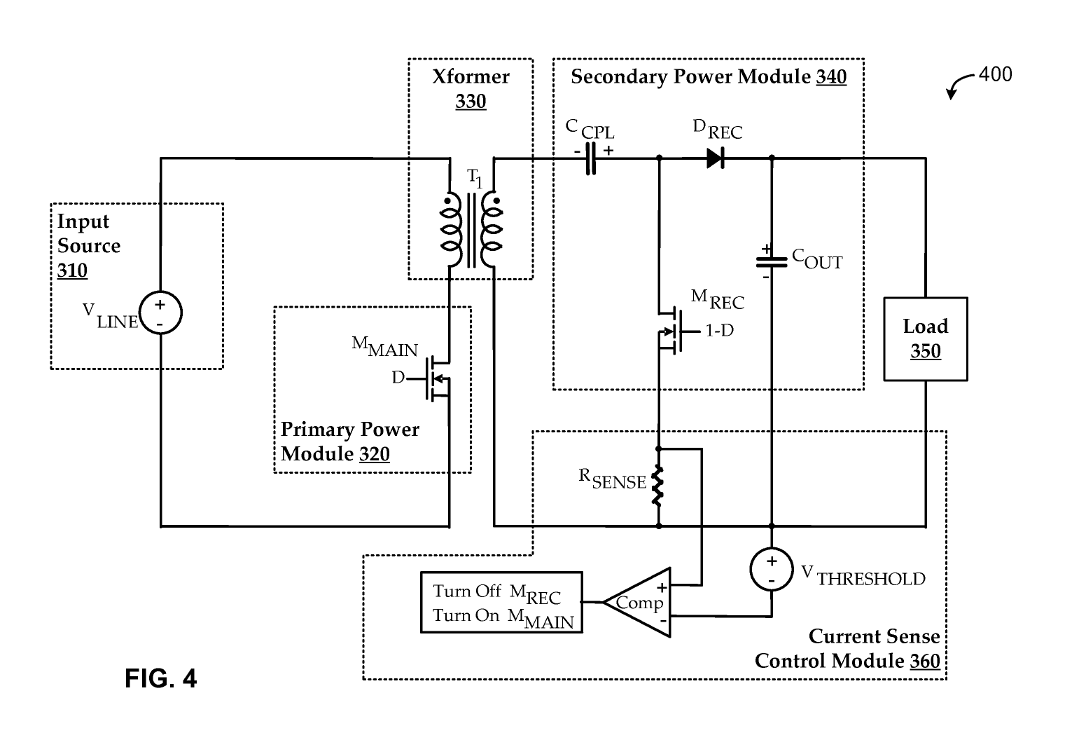

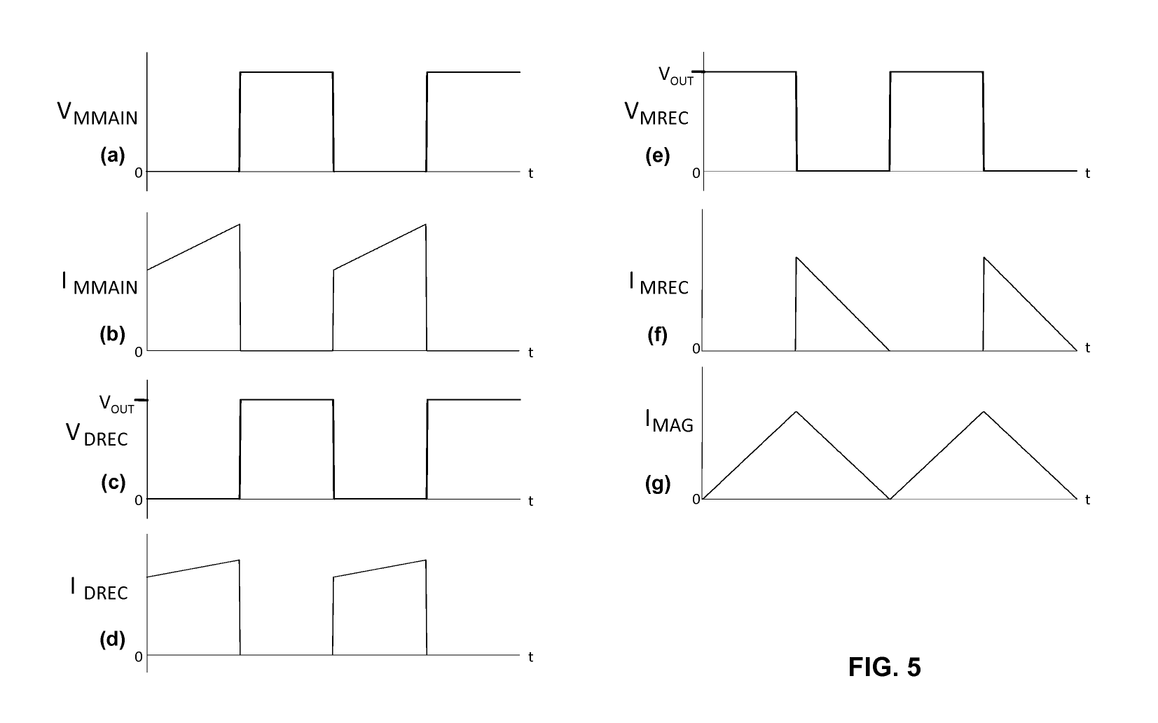

Turning to FIG. 4, a schematic diagram is shown of an illustrative ZCS-mode coupled inductor boost power converter 400, according to various embodiments. Illustrative wave forms describing the functionality of the ZCS-mode coupled inductor boost power converter 400 are shown in FIGS. 5A-5G. As illustrated, the ZCS-mode coupled inductor boost power converter 400 includes an input power source 310, a primary power module 320, a transformer 330, a secondary power module 340, a load 350, and a current sense control module 360.

The input power source 310 is illustrated as a source of DC power and voltage (V_{LINE}), the transformer 330 is illustrated as a coupled inductor (T1), and the load 350 is illustrated as a generic output load 350. The primary power module 320 includes one switching element, a main MOSFET switch (M_{MAIN}) configured to control (e.g., switch) current at the primary winding of the transformer 330. The secondary power module 340 includes two switching elements, a rectifier MOSFET switch (M_{REC}), and a rectifier diode switch (D_{REC}). The secondary power module 340 is further illustrated as including a coupling capacitor (C_{CPL}) and an output capacitor (C_{OUT}).

In the illustrative embodiment, the current sense control module 360 includes a sensing resistor (R_{SENSE}), configured effectively to produce a voltage drop that substantially correlates to (e.g., is proportional to) the secondary-side magnetizing current of the transformer 330. The current sense control module 360 may further include a threshold voltage generator and a comparator.

In some embodiments, the threshold voltage generator is configured to set a threshold voltage (V_{THRESHOLD}) that is slightly positive. When the magnetizing current through the secondary side of the transformer 330 approaches sufficiently close to zero, the voltage across the sensing resistor may fall below the threshold voltage set by the threshold voltage generator, causing the output of the comparator to switch.

The output of the comparator may be used as a control signal to affect switching of the primary power module 320. For example, when the magnetizing current through the secondary side of the transformer 330 approaches sufficiently close to zero, the output of the comparator may be configured to switch so as to turn ON the main MOSFET switch. This, in turn, may begin to charge the primary side of the transformer 330, which may thereby induce current in the secondary side of the transformer 330.

For example, as shown in FIGS. 5A-5G, the result may be a substantially zero current switching mode. When the magnetizing current through the secondary side of the transformer 330 (I_{MAG}) approaches sufficiently close to zero, as shown in FIG. 5G, the output of the comparator may be configured to switch so as to turn ON the main MOSFET switch (M_{MAIN}), as shown in FIGS. 5A and 5B (e.g., the figures show that the voltage through the main switch is substantially zero, and the current through the main switch begins to ramp up, respectively).

When the primary-side current ramps up (e.g., as in FIG. 5B), a secondary-side current may similarly ramp up (e.g., as shown in FIG. 5D). In some embodiments, this causes the rectifier diode switch (D_{REC}) to be ON (conducting) and the rectifier MOSFET switch (M_{REC}) to turn OFF (not conducting), as shown in FIGS. 5C and 5E, respectively. At some point, the switches effectively toggle, such that the main MOSFET switch (M_{MAIN}) and the rectifier diode switch (D_{REC}) turn OFF and the rectifier MOSFET switch (M_{REC}) turns ON. Power developed at the secondary power module 340 is then delivered to the load and the magnetizing current through the secondary side of the transformer 330 (I_{MAG}) once again begins to ramp down towards zero.

Notably, zero current switching may be achieved by enabling the magnetizing current to drop to zero current at the end of the second operating state. By requiring the magnetizing current to drop to zero current at the end of the second operating state, the switching frequency will vary with load variations. A variable switching frequency may have adverse effects of its own so a user will have to carefully weigh the trade offs of constant frequency operation versus variable frequency operation for the specific application.

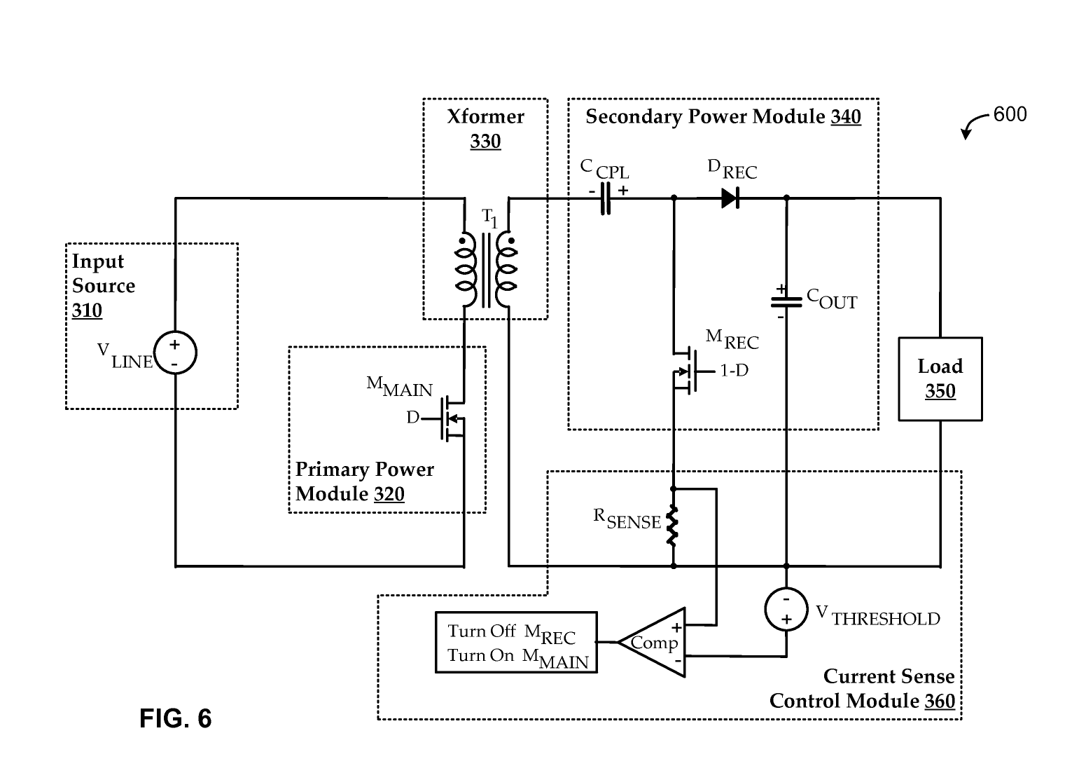

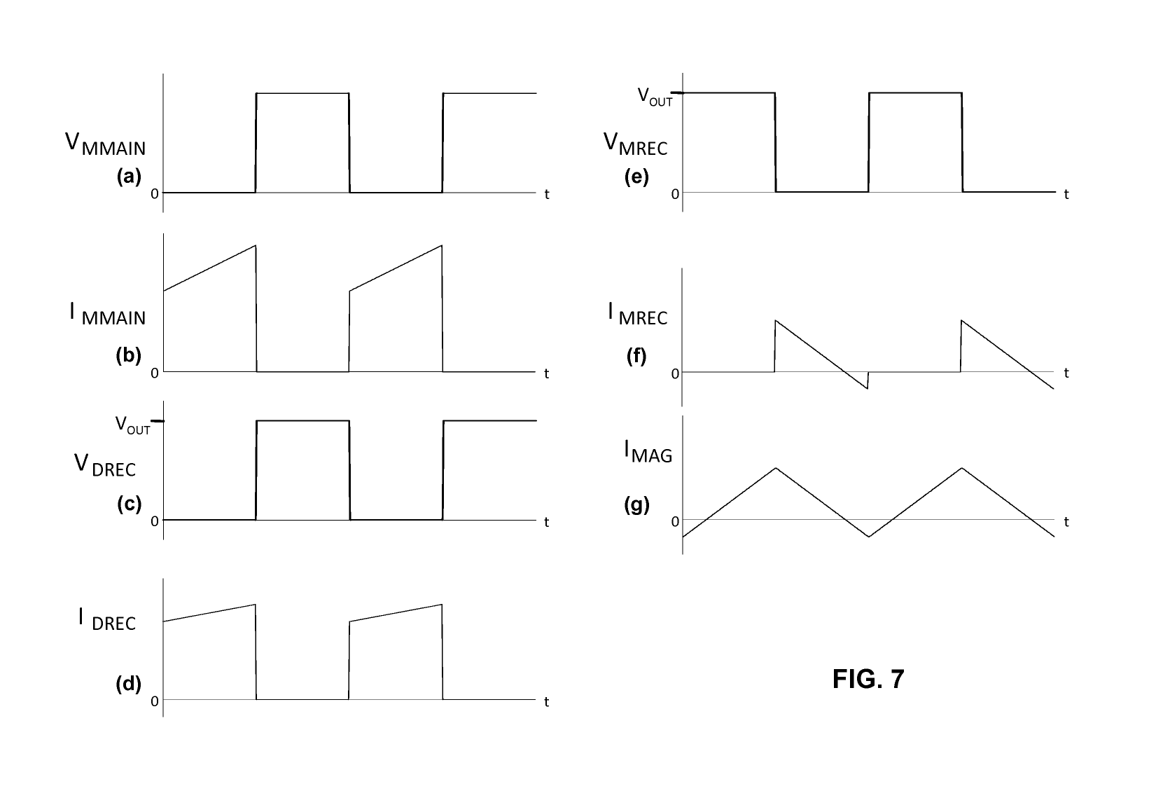

FIG. 6 shows a schematic diagram of an illustrative ZVS-mode coupled inductor boost power converter 600, according to various embodiments. Illustrative wave forms describing the functionality of the ZVS-mode coupled inductor boost power converter 600 are shown in FIGS. 7A-7G. As illustrated, the ZVS-mode coupled inductor boost power converter 700 includes an input power source 310, a primary power module 320, a transformer 330, a secondary power module 340, a load 350, and a current sense control module 360.

For the sake of clarity of description, the ZVS-mode coupled inductor boost power converter 600 is illustrated to be substantially identical to the ZCS-mode coupled inductor boost power converter 400 of FIG. 4, except for the polarity of the threshold voltage generator included in the current sense control module 360. In some embodiments, the threshold voltage generator is configured to set a threshold voltage (V_{THRESHOLD}) that is negative. When the magnetizing current through the secondary side of the transformer 330 falls sufficiently below zero, the voltage across the sensing resistor may similarly fall below the negative threshold voltage set by the threshold voltage generator, causing the output of the comparator to switch.

As in the ZCS-mode coupled inductor boost power converter 400 of FIG. 4, the output of the comparator may be used as a control signal to affect switching of the primary power module 320. For example, when the magnetizing current through the secondary side of the transformer 330 falls sufficiently below zero, the output of the comparator may be configured to switch so as to turn ON the main MOSFET switch (e.g., requiring substantially zero switching voltage). This, in turn, may begin to charge the primary side of the transformer 330, which may thereby induce current in the secondary side of the transformer 330.

For example, as shown in FIGS. 7A-7G, the result may be a substantially zero voltage switching mode. When the magnetizing current through the secondary side of the transformer 330 (I_{MAG}) falls sufficiently below zero, as shown in FIG. 7G, the output of the comparator may be configured to switch so as to turn ON the main MOSFET switch (M_{MAIN}), as shown in FIGS. 7A and 7B (e.g., the figures show that the voltage through the main switch is substantially zero, and the current through the main switch begins to ramp up, respectively).

When the primary-side current ramps up (e.g., as in FIG. 7B), a secondary-side current may similarly ramp up (e.g., as shown in FIG. 7D). In some embodiments, this causes the rectifier diode switch (D_{REC}) to be ON (conducting) and the rectifier MOSFET switch (M_{REC}) to be OFF (not conducting), as shown in FIGS. 7C and 7E, respectively. At some point, the switches effectively toggle. Power developed at the secondary power module 340 is then delivered to the load (e.g., through the rectifier diode switch (D_{REC})) and the magnetizing current through the secondary side of the transformer 330 (I_{MAG}) once again begins to fall towards (and ultimately below) zero.

It is worth noting that, in the embodiment illustrated above, the main MOSFET switch (M_{MAIN}) and the rectifier MOSFET switch (M_{REC}) are implemented with MOSFETs, which may manifest the property that the channel current can be bi-directional (e.g., as shown in FIG. 7F). It is also worth noting that the threshold voltage may be selected to correspond to an amount of magnetizing current and magnetizing energy sufficient to achieve substantially zero voltage switching for the main MOSFET switch (M_{MAIN}). During the turn on transition of the main MOSFET switch (M_{MAIN}), magnetizing energy stored in the core of the transformer 330 is transferred to an output capacitance of the main MOSFET switch (M_{MAIN}) and to other apparent capacitances coupled to the drain terminal of the main MOSFET switch (M_{MAIN}) while the channel of the main MOSFET switch (M_{MAIN}) is OFF. For example, other capacitances coupled to the drain of the main MOSFET switch (M_{MAIN}) may include intra-winding and inter-winding capacitances of the transformer 330, the junction capacitance of rectifier diode switch (D_{REC}), the output capacitance of rectifier MOSFET switch (M_{REC}), parasitic capacitances associated with copper traces on a printed circuit board to which the drain of the main MOSFET switch (M_{MAIN}) is coupled and parasitic capacitances of other circuit elements coupled to the drain of the main MOSFET switch (M_{MAIN}), etc. The capacitances may be directly coupled, capacitively coupled, or magnetically coupled to the drain of the main MOSFET switch (M_{MAIN}).

In effect, zero voltage switching may be achieved by enabling the reversing of the magnetizing current during each operating state. For example, in order to achieve zero voltage switching, the magnetizing current should exceed a threshold value that corresponds to an energy level sufficient to drive the drain voltage of the main switch to zero volts. The magnetizing current may exceed the threshold with the consequence that the peak to peak AC magnetizing current is larger than necessary to achieve zero voltage switching.

A fixed frequency control scheme may result in the magnetizing current exceeding the threshold current at light loads which may increase conduction losses. By limiting the magnetizing current to the threshold current, the conduction losses may be reduced but the switching frequency may still vary with load variations. A variable switching frequency may have adverse effects of its own so a user will have to carefully weigh trade-offs of constant frequency operation versus variable frequency operation for the specific application.

Conduction loss penalties associated with magnetizing current reversal to achieve zero voltage switching is well known for buck and flyback converters. In these converters the magnetizing current is equal to the main switch current during the on time of the main switch. In coupled boost converters, the magnetizing current may be a fraction of the total main switch current, so that the magnitude of the conduction loss penalty associated with magnetizing current reversal in a coupled boost converter may be much smaller than in a similar buck converter or flyback converter topology. For example, the magnetizing current itself may be smaller, and the conduction loss penalty may depend on the square of this current.

Further, the conduction loss penalty in buck and flyback converters may be highly line voltage dependent, so that in order to achieve zero voltage switching at low line voltages, the conduction loss penalty at high line voltage may be excessive to the extent that the conduction loss penalty may eliminate any efficiency gains achieved by zero voltage switching. Thus, in those topologies, the technique may be impractical for many, if not most, applications. In a coupled boost converter, the AC magnetizing current is load voltage dependent, but may be less line voltage dependent than a buck or flyback converter. Typical commercial applications may require a fixed load voltage and operation over a range of line voltages, which is suitable and practical for the zero voltage switching techniques based on magnetizing current reversal described herein with reference to various embodiments of coupled inductor boost converter topologies.

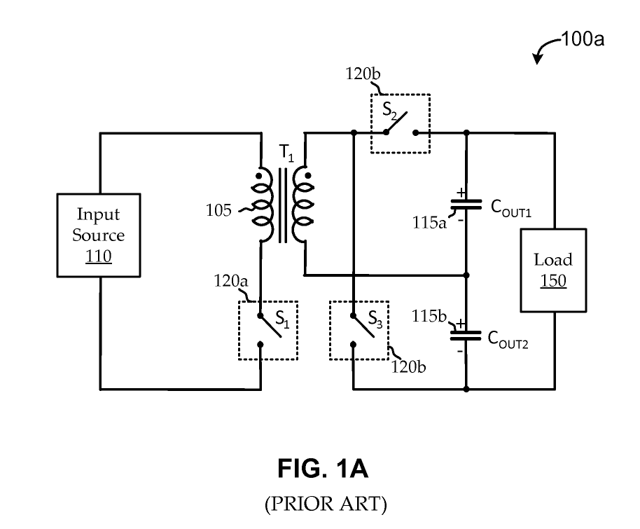

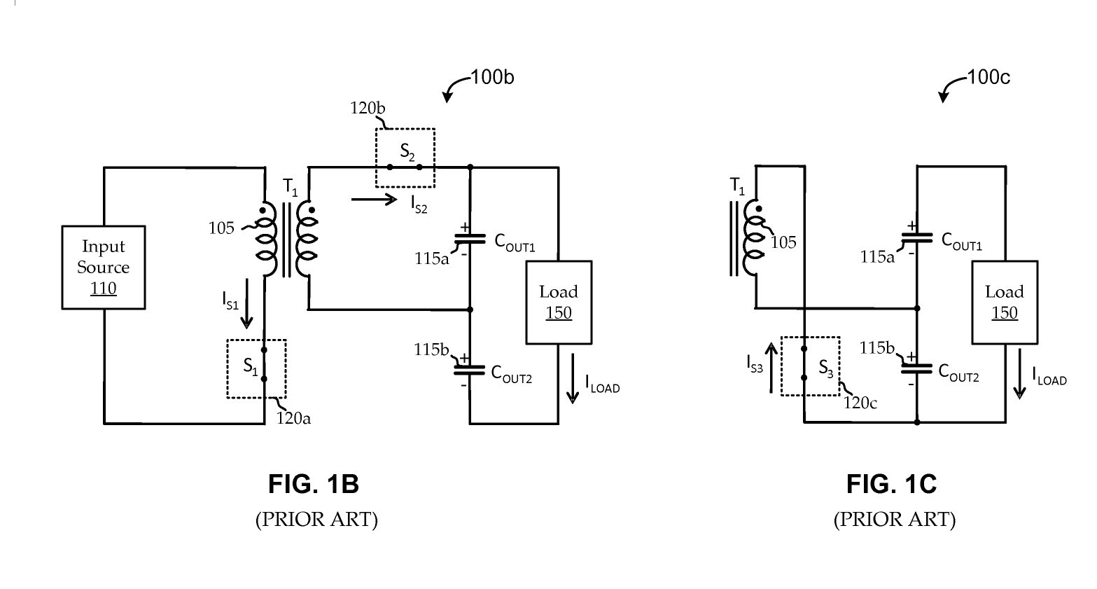

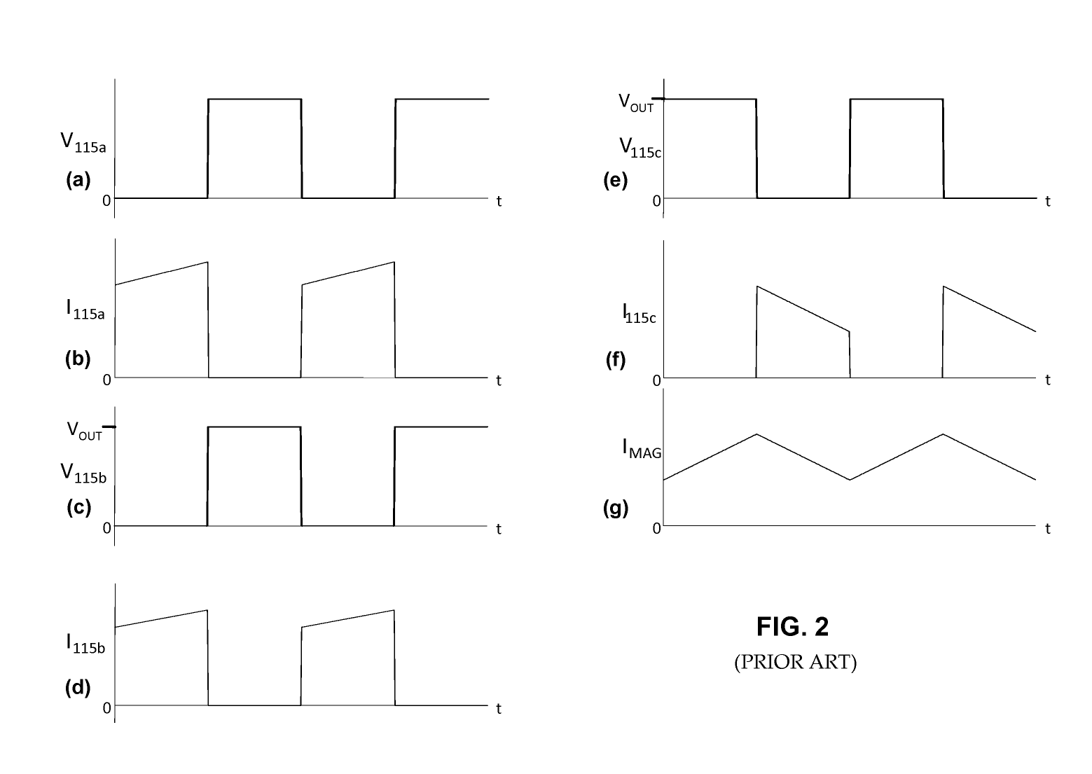

For the sake of added clarity, it may be useful to compare the second operating states of a typical coupled inductor boost power converter (e.g., as shown in FIG. 1A), a ZCS-mode coupled inductor boost power converter (e.g., as shown in FIG. 4), and a ZVS-mode coupled inductor boost power converter (e.g., as shown in FIG. 6). Illustrative embodiments of their respective magnetizing currents are shown in FIGS. 2G, 5G, and 7G, respectively. According to FIG. 2G, the typical coupled inductor boost power converter configuration operates in a continuous mode, with the magnetizing current always staying significantly positive.

According to the ZCS mode shown in FIG. 5G, the magnetizing current decreases to zero (e.g., or to a positive level sufficiently near zero). The coupled inductor boost power converter therefore operates in a boundary mode, such that, when the next primary-side charging cycle begins (e.g., when the main MOSFET switch (M_{MAIN}) turns ON), there will be substantially no rectifier reverse recovery effects.

According to the ZVS mode shown in FIG. 7G, the magnetizing current decreases to zero and reverses direction. The coupled inductor boost power converter therefore operates so that, when the next primary-side charging cycle begins (e.g., when the main MOSFET switch (M_{MAIN}) turns ON), the magnetizing current is directed towards decreasing the main MOSFET switch (M_{MAIN}) voltage. When the threshold voltage is appropriately set, the main MOSFET switch (M_{MAIN}) may be turned ON at substantially zero voltage, for example, when the magnetizing energy is sufficient to drive the main MOSFET switch (M_{MAIN}) voltage to zero volts. For example, this may effectively cause the drain circuit turn on switching losses of the main MOSFET switch (M_{MAIN}) to be eliminated.

It will be appreciated that the ZCS and ZVS modes may be effectuated in various ways according to other embodiments. In some embodiments, as described with reference to FIGS. 3A and 4-7G, current sense control module 360 can be implemented with a threshold voltage generator and comparator to generate an appropriate switching control signal for the primary power module 320. In other embodiments, for example, as illustrated with reference to FIG. 3B, a current modeling module 370 may be used to generate a signal representing the magnetizing current of the transformer 330, which can then be used to generate an appropriate switching control signal for the primary power module 320. In still other embodiments, component selection, timing, and/or other techniques are used to implement ZCS and/or ZVS modes of the coupled inductor boost power converter.

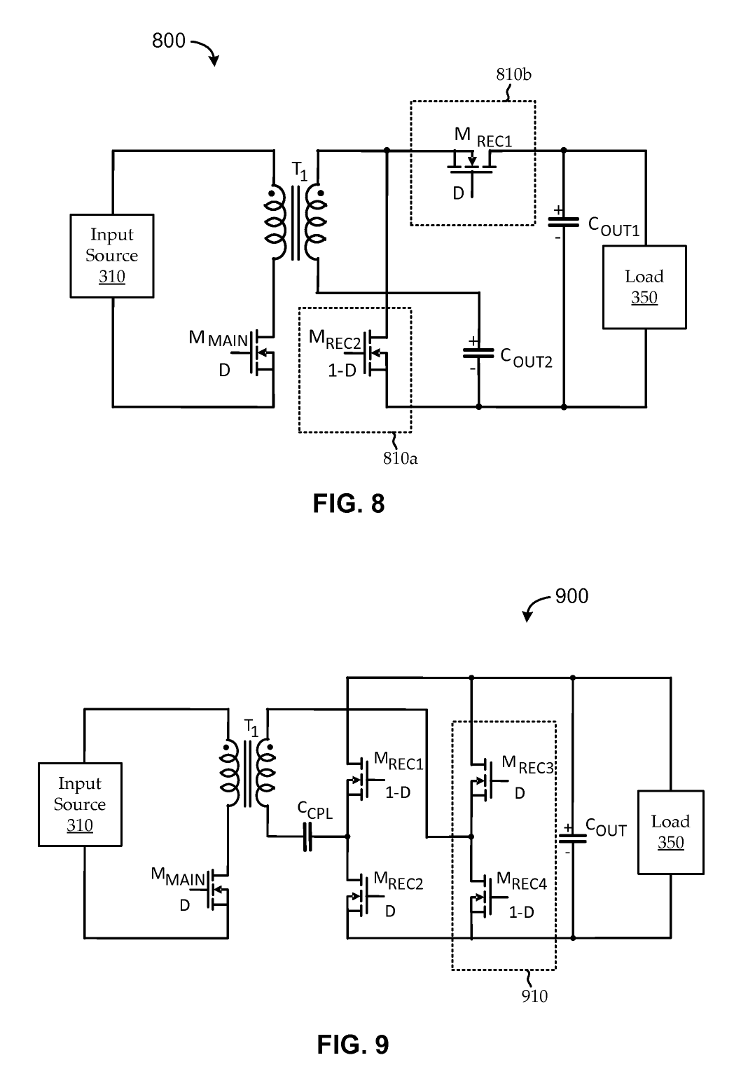

It will be further appreciated that many different embodiments of coupled inductor boost power converters can be controlled in ZCS and/or ZVS modes of operation, according to embodiments of the invention. For the sake of added clarity, a number of illustrative embodiments of coupled inductor boost power converter topologies are illustrated in FIGS. 8-20. The respective schematic diagrams are shown without current sense control module 360 or current modeling module 370 to focus the disclosure on the coupled inductor boost power converter being illustrated by the respective figure. However, it will be appreciated that any of the control techniques discussed above can be applied in the context of any of these or other coupled inductor boost power converter topologies.

Operation of the various embodiments of FIGS. 8-18 will be appreciated by those of skill in the art. As such, the embodiments will be described only to the extent necessary to add clarity and enablement to the disclosure. Turning to FIG. 8, a schematic diagram is shown of an illustrative coupled inductor boost power converter 800, according to various embodiments. The converter 800 of FIG. 8 is similar to the converters illustrated and described with reference to FIGS. 4 and 6, except that all the switching elements are implemented using MOSFETs. In particular, the rectifier MOSFET switch (M_{REC}) of FIGS. 4 and 6 are implemented as rectifier MOSFET switch (M_{REC2}) 810a, and the rectifier diode switch (D_{REC}) of FIGS. 4 and 6 is implemented using another rectifier MOSFET switch (M_{REC1}) 810b.

FIG. 9 shows a schematic diagram of another illustrative coupled inductor boost power converter 900 that is similar to the converter 800 of FIG. 8, but with secondary side switches implemented as a pair of switches in a full bridge rectifier arrangement 910, according to various embodiments. In some embodiments, the full bridge arrangement allows the secondary winding and switch currents to be reduced by a factor of around two as compared with an implementation having just two secondary side switches. In some circumstances, the combination of lower winding and switch current and more switches yields an efficiency advantage, since the conduction losses in windings and switches may depend on the squares of the currents in the windings and switches.

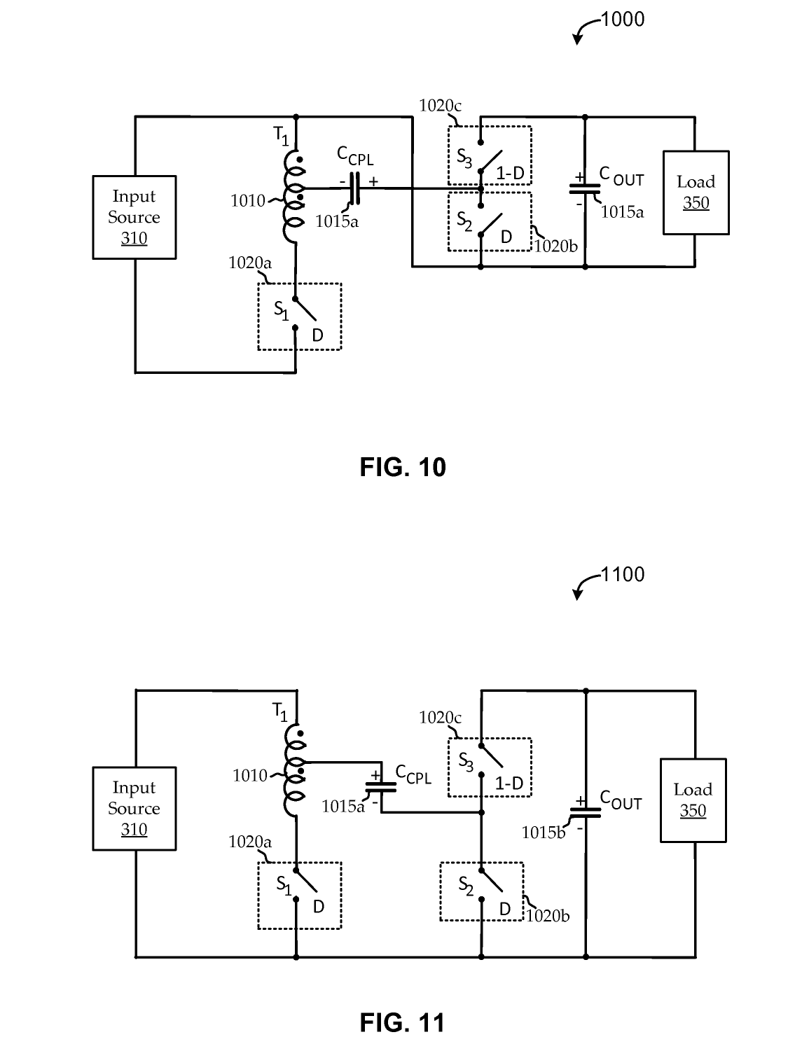

FIG. 10 shows a schematic diagram of an illustrative tapped inductor boost power converter 1000, according to various embodiments. A first terminal of a tapped inductor 1010 is connected to a first terminal of input source 310 (e.g., a DC input source of voltage and power). A second terminal of tapped inductor 1010 is connected to a first terminal of a capacitor 1015a. A third terminal of tapped inductor 1010 is connected to a first terminal of a first switch 1020a. A second terminal of first switch 1020a is connected to a second terminal of input source 310. A second terminal of capacitor 1015a is connected to a first terminal of a second switch 1020b and to a first terminal of a third switch 1020c. A second terminal of second switch 1020b is connected to a first terminal of an output capacitor 1015b, to the first terminal of the tapped inductor 1010 (i.e., the first input source 310 terminal), and to a first terminal of a load 350. A second terminal of third switch 1020c is connected to a second terminal of output capacitor 1015b and to a second terminal of the load 350.

In operation the converter 1000 of FIG. 10 has two operating states. During a first operating state, the first switch 1020a and the second switch 1020b are ON, and the third switch 1020c is OFF. In the first operating state, current ramps up in first switch 1020a. The current in first switch 1020a has two components: the magnetizing current of tapped inductor 1010; and an induced current that is related to the second switch 1020b current. The second switch 1020b current charges the capacitor 1015a, and the capacitor 1015b discharges into the load 350. In a second operating state, the first switch 1020a and the second switch 1020b are OFF, and the third switch 1020c is ON. During the second operating state, the tapped inductor 1010 magnetizing current flows in the third switch 1020c and ramps down. Capacitor 1015a is discharged and capacitor 1015b is charged. The third switch 1020c current also supports the load 350.

It is worth noting that the embodiment of FIG. 10 illustrates that coupled inductor boost converter functionality can be implemented according to various topologies. For example, as illustrated in FIG. 10, a tapped inductor may yield similar functionality to a coupled inductor when implemented according to certain topologies. As such, as used herein, the phrase “coupled inductor” in intended to include any similarly functioning circuit topologies, such as a tapped inductor.

FIG. 11 shows a schematic diagram of another illustrative tapped inductor boost power converter 1100 that is similar to the converter 1000 of FIG. 10, except that the first load 350 terminal connects to the second input source 310 terminal, rather than the first input source 310 terminal, according to various embodiments. It will be appreciated that this type of topology may provide easier feedback from the load to the control circuit for the first switch 1020a (e.g., as described above with reference to the current sense control module 360). For example, this may result from both the first switch 1020a and the load 350 having the same reference voltage.

Notably, the topology of FIG. 11 may require that capacitor 1015a have a higher voltage rating in certain embodiments. Also, in some embodiments, certain parameter and component values are selected for ZVS mode implementation. For example, the magnetizing inductance of tapped inductor 1010 is selected to be sufficiently small that the magnetizing current reverses during each operating state and the magnetizing energy of tapped inductor 1010 drives a zero voltage turn on switching transition for the first switch 1020a.

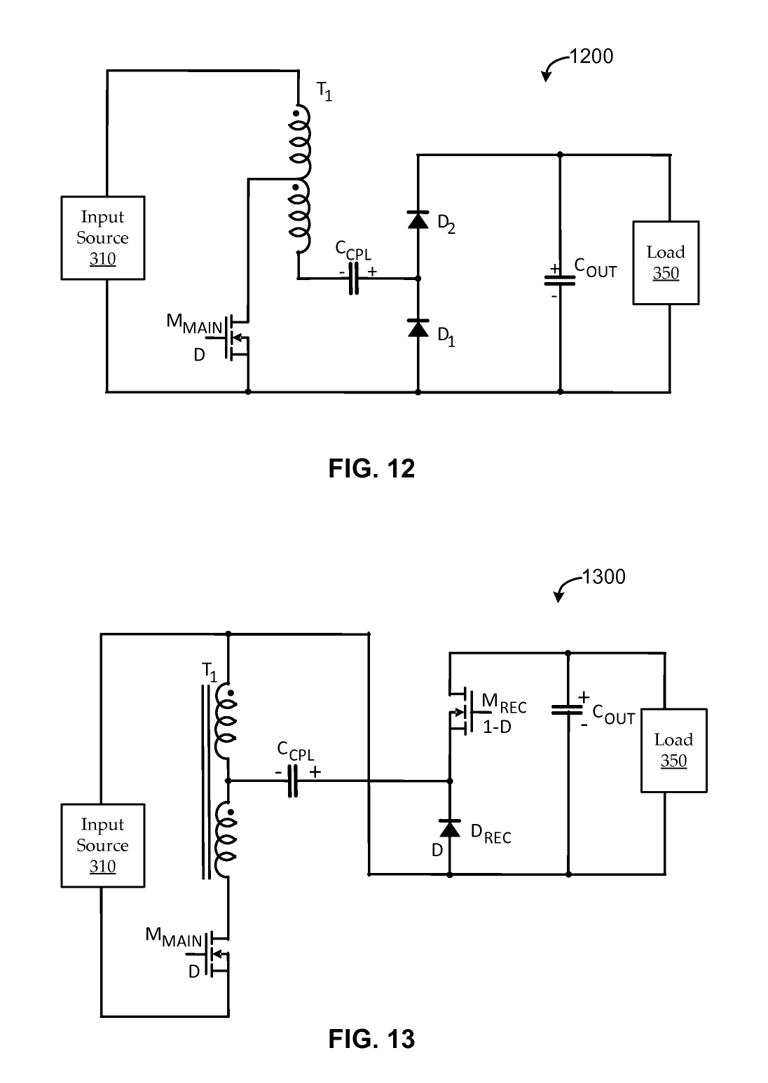

FIG. 12 shows a schematic diagram of yet another illustrative tapped inductor boost power converter 1200 that is similar to the converter 1000 of FIG. 10, configured to allow the load voltage to be larger than the line voltage except that the first load 350 terminal connects to the second input source 310 terminal, rather than the first input source 310 terminal, according to various embodiments. For example, in embodiments like those illustrated by FIGS. 10 and 11, the load 350 voltage can be smaller than the line (i.e., input source 310) voltage.

FIG. 13 shows a schematic diagram of still another illustrative tapped inductor boost power converter 1300 that is similar to the converter 1000 of FIG. 10, except that certain switches are implemented using MOSFETs, according to various embodiments. In particular, according to the converter 1300 of FIG. 13, the first switch 1020a and the third switch 1020c illustrated in FIG. 10 are implemented as MOSFETs, and the second switch 1020b illustrated in FIG. 10 is implemented as a diode rectifier. By using the MOSFETs as synchronous rectifiers in the embodiment of converter 1300, a ZVS mode can be implemented. For example, the synchronous rectifier may enable the reversal of magnetizing current for zero voltage switching, as described above.

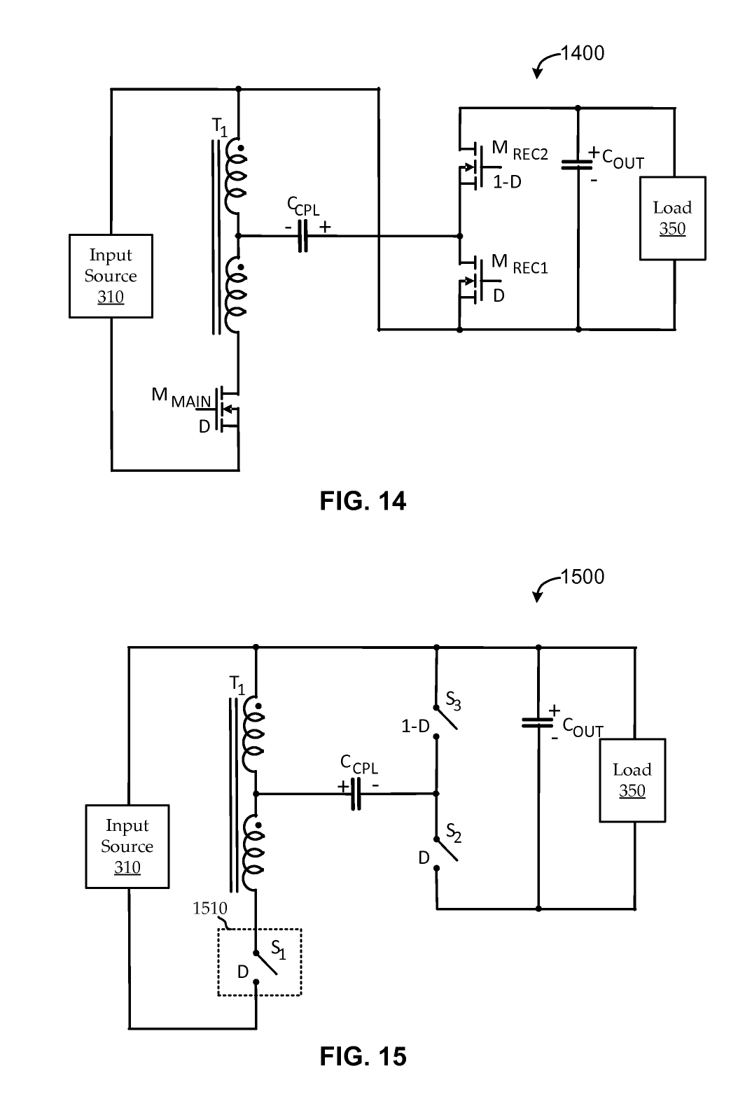

Of course, other configurations are possible in which more or fewer MOSFETs may be used as various switching elements of the converter. For example, FIG. 14 shows a schematic diagram of even another illustrative tapped inductor boost power converter 1400 that is similar to the converter 1000 of FIG. 10, except that all switches are implemented using MOSFETs, according to various embodiments. This type of topology may yield lower switch conduction losses, for example, because rectifier diode forward voltage losses (e.g., as in the converter 1300 implementation of FIG. 13) may be effectively eliminated by using all MOSFETs.

FIG. 15 shows a schematic diagram of another illustrative tapped inductor boost power converter 1500 that is similar to the converter 1000 of FIG. 10, except that the second terminal of the load 350 is connected to the first terminal of the input source 310 (according to the conventions discussed with reference to FIG. 10), according to various embodiments. Embodiments of the converter 1500 provide a DC voltage at an intermediate level between the DC levels of the DC input source 310. In some embodiments, a DC level shifting feedback signal is used to provide feedback from the load 350 to the reference level of the main switch 1510. Notably, the amount that the level needs to be shifted and the power loss associated with the level shift may be less for the converter 1500 of FIG. 15 than the amount needed by the converter 1000 of FIG. 10.

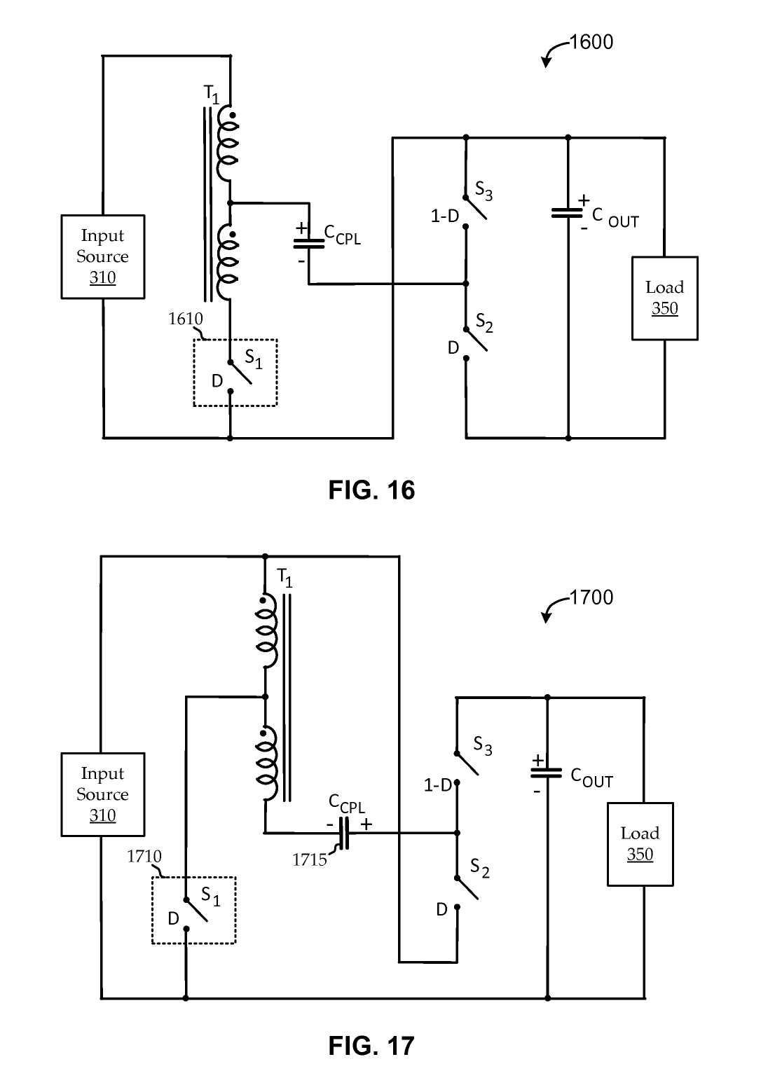

FIG. 16 shows a schematic diagram of yet an illustrative tapped inductor boost power converter 1600 that is similar to the converter 1500 of FIG. 15, except that the second terminal of the load 350 is connected to the second terminal of the input source 310 (e.g., according to the conventions discussed with reference to FIG. 10), according to various embodiments. For example, an output terminal DC voltage is generated to be negative with respect to the reference voltage for the main switch 1610. Embodiments of the converter 1600 may be used for applications in which a negative load voltage is desired.

FIG. 17 shows a schematic diagram of another illustrative tapped inductor boost power converter 1700 that is similar to the converter 1500 of FIG. 15, except that the load 350 shares a reference voltage (e.g., ground) with the input source 310 and the main switch 1710, according to various embodiments. Embodiments of this topology may provide a load 350 voltage that exceeds twice the input source 310 voltage. In some embodiments, during the ON time of the main switch 1710, the voltage applied to the capacitor 1715 is greater than the input source 310 voltage. When the main switch 1710 is turned OFF, the winding voltage plus the capacitor 1715 voltage are added to the input source 310 voltage to form the load 350 voltage.

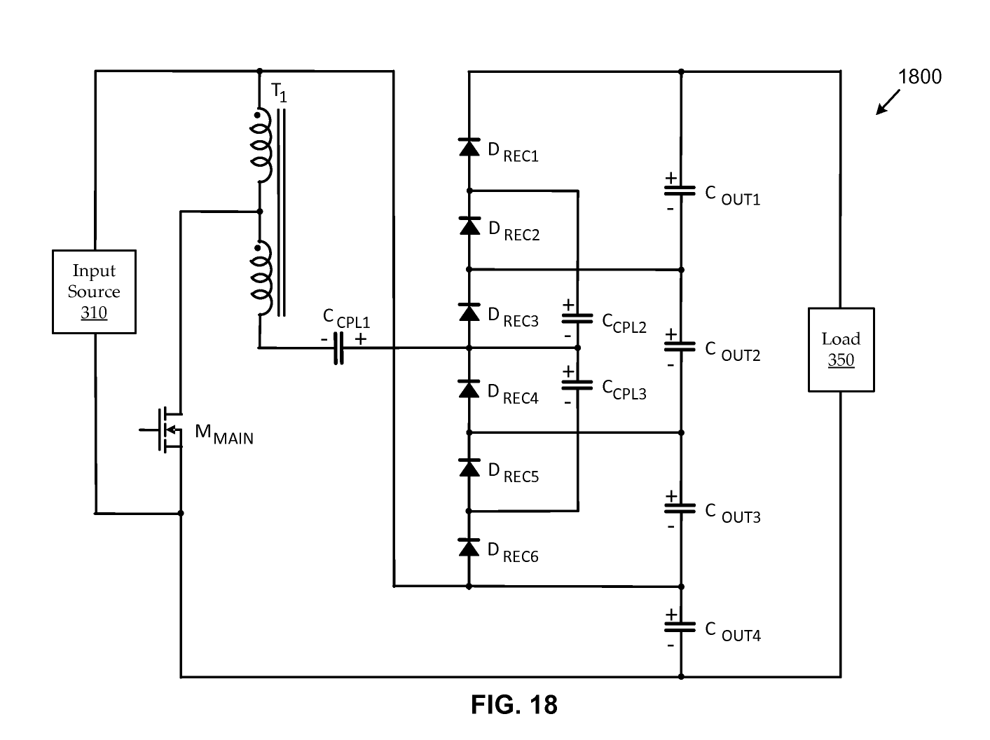

FIG. 18 shows a schematic diagram of an illustrative tapped inductor boost power converter 1800 that is similar to the converter 1700 of FIG. 17, except that a diode capacitance multiplier rectifier network is used to multiply the output load 350 voltage, according to various embodiments.

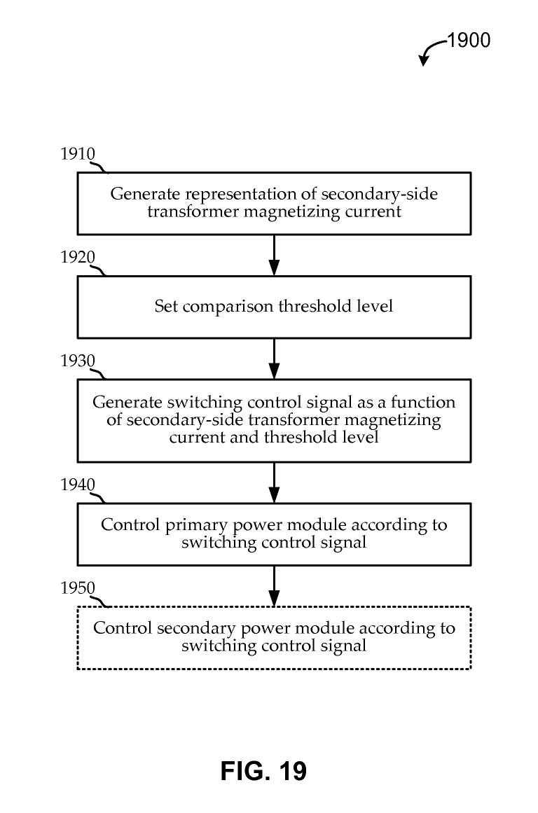

FIG. 19 shows a flow diagram of an illustrative method 1900 for using a coupled inductor boost power converter in ZCS and/or ZVS mode, according to various embodiments. The method 1900 begins at block 1910 by generating a representation of a secondary side transformer magnetizing current in a coupled inductor boost converter. For example the representation may be generated at block 1910 by current sensing (e.g., using a resistor to develop a voltage proportional to the magnetizing current), by reconstruction (e.g., using an integrator and signal processor to artificially reconstruct the current), etc.

At block 1920, a comparison threshold level may be set. For example, a voltage threshold may be set for comparison against a voltage generated to represent the magnetizing current in block 1910. As described above, the threshold level may be set for a ZCS boundary mode of operation (e.g., slightly above zero), for a ZVS boundary mode of operation (e.g., at a negative level to indicate magnetizing current reversal), or at some other useful level.

At block 1930, a switching control signal is generated as a function of the magnetizing current representation from block 1910 and the comparison threshold of block 1920. In some embodiments, the switching control signal is configured to drive the converter in two operating states, both of which deliver energy to the load. The switching control signal may then be used, at block 1940, to control a primary power module of the converter. For example, the primary power module of the converter may be configured to switch the primary side of the magnetizing element (e.g., the coupled inductor) according to the switching control signal. As described above, in some embodiments, the switching control signal (e.g., or another signal derived from the switching control signal) may also be used, at block 1950, to control the secondary power module of the converter. For example, the switching control signal may directly or indirectly control switches on the secondary side of the converter.

It should be noted that the methods, systems, and devices discussed above are intended merely to be examples. For example, embodiments described with reference to small-signal and/or large-signal functionality, analog or digital signals, etc. are intended only as examples. Further, specific circuit elements are shown and/or described in some embodiments merely for clarity of description, and are not intended to be limiting.

For example, it will be appreciated from the above description that many topologies are possible, and that all the various topologies may deliver energy to the load network during both operating states. This may translate into lower switch and winding RMS currents, for example, as compared to conventional flyback derived circuits in which energy is delivered to the load network only during the operating state in which the main switch is OFF. Also, all of the embodiments are illustrated as having load network switches with voltage stress that is less than or equal to the output voltage or load 350 voltage. This may enable the use of switches with lower voltage ratings and lower forward voltages or lower ON resistances, for example, than those switches that may be required for conventional flyback derived circuits. Because winding voltage stresses may also be much lower than the winding voltage stresses of comparable flyback derived circuits, the number of winding turns for load 350 network connected windings may be less, and the winding resistance and associated winding conduction losses may be similarly reduced.

Further, substantially all the energy delivered to the load 350 in a flyback derived circuit may first be stored in magnetizing energy in a magnetic core. According to embodiments of the coupled inductor boost circuits described above, only a fraction of the energy delivered to the load may be derived from magnetic energy in a magnetic core. Some of the energy delivered to the load may be transferred through the coupled inductor during the ON time of the main switch by ideal transformer action, which may require substantially no stored magnetic energy. As a result of the lower stored magnetic energy and the winding conduction loss advantages, the magnetic element for a coupled inductor boost derived design may be smaller and less costly, for example, than those of a flyback transformer designed for the same application.

It will be appreciated that, by enabling the magnetizing current in a coupled inductor boost converter to drop to zero and/or even to reverse in each switching cycle, a novel coupled inductor boost converter is formed which can be driven in a ZCS and/or ZVS mode for either zero current or zero voltage turn on switching for all switches for all transitions. Further, these modes may be achieved without using a high side active switch. Some embodiments of the coupled inductor boost converter described herein further achieve higher or lower output voltage and/or reduced component stresses. Even further, some embodiments described herein illustrate that, by tapping an inductor in a boost derived converter and capacitively coupling the winding tap to a rectifier and load network, new non-isolated power converters may be revealed which have cost and efficiency advantages, for example, over conventional flyback or buck boost derived power converters.

Circuits with higher orders of diode capacitance multipliers can be formed with higher output voltages by adding diodes and capacitors (e.g., to the converter 1800 of FIG. 18). Further embodiments may be achieved by using similar circuit topologies, but with multiple interleaved parallel circuits that share common capacitors, with polarity of the input or output reversed from that illustrated, having coupled magnetic circuit elements with more than two windings and circuits with more than one output, etc. Even further, while many embodiments are illustrated with simple switches, other embodiments may include N-channel MOSFETs, P-channel MOSFETs, IGBTs, JFETs, bipolar transistors, junction rectifiers, schottky rectifiers, etc. Other embodiments may also include additional circuit components, such as snubbers, both active and passive, and clamps for achieving improved electromagnetic compatibility. Still other embodiments may include current sense resistors and/or current transformers for sensing switch currents placed in series with one or more switches, for example, as these current sensing circuit elements may constitute a direct wire path to or from the switch (e.g., they may not significantly alter the operating currents or voltages of the circuit).

It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

It should also be appreciated that the following systems, methods, and software may individually or collectively be components of a larger system, wherein other procedures may take precedence over or otherwise modify their application. Also, a number of steps may be required before, after, or concurrently with the following embodiments.

Specific details are given in the description to provide a thorough understanding of the embodiments. However, it will be understood by one of ordinary skill in the art that the embodiments may be practiced without these specific details. For example, well-known circuits, processes, algorithms, structures, waveforms, and techniques have been shown without unnecessary detail in order to avoid obscuring the embodiments.

Further, it may be assumed at various points throughout the description that all components are ideal (e.g., they create no delays and are lossless) to simplify the description of the key ideas of the invention. Those of skill in the art will appreciate that non-idealities may be handled through known engineering and design skills. It will be further understood by those of skill in the art that the embodiments may be practiced with substantial equivalents or other configurations. For example, circuits described with reference to N-channel transistors may also be implemented with P-channel devices, or certain elements shown as resistors may be implemented by another device that provides similar functionality (e.g., an MOS device operating in its linear region), using modifications that are well known to those of skill in the art.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Accordingly, the above description should not be taken as limiting the scope of the invention, as described in the following claims:

What is claimed is:

1. A power converter system, comprising:
a coupled inductor power converter subsystem, comprising:
a transformer module having a primary side and a secondary side electromagnetically coupled with the primary side, the transformer module configured to produce second energy on the secondary side as a function of first energy developed on the primary side of the transformer module;
a primary power module, coupled with the primary side of the transformer module and configured to control the first energy developed on the primary side of the transformer module at least according to input power received from a power source; and
a secondary power module, coupled with the secondary side of the transformer module and configured to deliver at least some of the second energy from the secondary side of the transformer module to an output; and
a control subsystem, coupled with the primary power module and configured to further control the first energy developed on the primary side of the transformer module according to the second energy produced on the secondary side of the transformer module.

2. The power converter system of claim 1, wherein the control subsystem is configured to drive the coupled inductor power converter subsystem to operate in a substantially zero current switching mode by allowing a magnetizing current developed in the transformer module to drop substantially to zero during each operating cycle of the coupled inductor power converter subsystem.

3. The power converter system of claim 2, wherein:
the primary power module is configured to operate in an OFF operating state and in an ON operating state, and to transition the primary power module from the OFF operating state to the ON operating state when a magnetic energy of the transformer module drops substantially to zero.

4. The power converter system of claim 1, wherein the control subsystem is configured to drive the coupled inductor power converter subsystem to operate in a substantially zero voltage switching mode by allowing a magnetizing current developed in the transformer module to fall sufficiently below zero during each operating cycle of the coupled inductor power converter subsystem to produce a reversed magnetizing current, such that the reversed magnetizing current is sufficient to switch the primary power module using a substantially zero switching voltage.

5. The power converter system of claim 4, wherein:
the primary power module is configured to operate in an OFF operating state for an OFF duration and in an ON operating state for an ON duration, such that a magnetic energy develops on the transformer module during the OFF duration in an amount sufficient to fully discharge an intrinsic output capacitance of the primary power module during a transition of the primary power module from the OFF operating state to the ON operating state.

6. The power converter system of claim 1, wherein the primary power module comprises a first switching sub-module, electrically coupled with the power source and the primary side of the transformer module, and configured to control flow of current from the power source to the primary side of the transformer module so as to control the first energy developed on the primary side of the transformer module.

7. The power converter system of claim 6, wherein the secondary power module comprises:
a second switching sub-module electrically coupled with a first terminal of the output and configured to switch substantially in synchronization with the first switching sub-module; and
a third switching sub-module electrically coupled with a second terminal of the output and configured to switch substantially in anti-synchronization with the first switching sub-module.

8. The power converter system of claim 6, wherein:
the transformer module is configured to produce a magnetizing current in a coupled inductor, the magnetizing current having an AC component and a DC component, the AC component having a magnitude that is at least twice that of the DC component; and
the coupled inductor power converter subsystem is configured such that a magnetizing energy corresponding to the magnetizing current contributes to discharging an intrinsic output capacitance of the first switching sub-module during a turn-on switching transition of the first switching sub-module.

9. The power converter system of claim 1, wherein the primary power module and the secondary power module are configured to operate in a first operating state and a second operating state, such that at least some of the second energy from the secondary side of the transformer module is delivered to the output during both the first operating state and a second operating state.

10. The power converter system of claim 1, wherein the transformer module comprises:
a coupled inductor having a primary winding at the primary side, a secondary winding at the secondary side, and a magnetic core structure between the primary side and the secondary side, the primary winding and the secondary winding configured to be mutually magnetically coupled, and the magnetic core structure configured to store magnetic energy.

11. The power converter system of claim 1, wherein the transformer module comprises:
a tapped inductor having at least three terminals and configured to manifest a primary winding and a secondary winding at the primary side and the secondary side of the transformer module of the coupled inductor power converter subsystem, respectively.

12. The power converter system of claim 1, wherein the control subsystem comprises:
a representation module, configured to generate a representation of magnetizing energy produced on the secondary side of the transformer module,
the control subsystem configured to generate a control signal as a function of the representation of the magnetizing energy and to use the control signal to contribute to control the first energy developed on the primary side of the transformer module.

13. The power converter system of claim 12, wherein the representation module comprises:
a sensor configured to sense the magnetizing energy produced on the secondary side of the transformer module and output a signal as the representation.

14. A method for power conversion, comprising:
generating a first signal corresponding to magnetizing energy developed on a secondary side of a transformer in a coupled inductor power converter;
selecting a comparison threshold;
generating a second signal as a function of the first signal and the comparison threshold; and
controlling a primary side of the transformer in the coupled inductor power converter as a function of the second signal such that the coupled inductor power converter operates in an OFF operating state and in an ON operating state during each converter operating cycle, and transitions from the OFF operating state to the ON operating state occur according to the second signal.

15. The method of claim 14, wherein controlling the primary side of the transformer in the coupled inductor power converter as a function of the second signal comprises:
driving a transition of the coupled inductor power converter from the OFF operating state to the ON operating state when a magnetic energy of the transformer drops substantially to zero.

16. The method of claim 14, wherein the coupled inductor power converter is configured such that a magnetic energy develops on the transformer during the OFF operating state in an amount sufficient to fully discharge an intrinsic output capacitance of a switching component on the primary side during a transition from the OFF operating state to the ON operating state.

17. The method of claim 14, wherein generating the first signal corresponding to the magnetizing energy developed on the secondary side of the transformer in the coupled inductor power converter comprises:
sensing a magnetizing current in the transformer,
the first signal generated as a function of the sensed magnetizing current.

18. The method of claim 14, wherein generating the first signal corresponding to the magnetizing energy developed on the secondary side of the transformer in the coupled inductor power converter comprises:
providing a modeling circuit substantially electrically isolated from the secondary side of the transformer and configured to generate an output corresponding to the magnetizing energy developed on the secondary side of the transformer in the coupled inductor power converter; and
generating the first signal as a function of the output of the modeling circuit.

19. A power converter system, comprising:
a coupled inductor power converter subsystem having a transformer, a primary side of the transformer being configured to be driven by a primary power module, the primary power module comprising a means for switching configured to control first energy developed on the primary side of the transformer;
means for generating a representation of second energy developed on a secondary side of the transformer; and
means for controlling the means for switching so as to further control the first energy developed at the primary side of the transformer module according to the second energy developed at the secondary side of the transformer.

20. The power converter system of claim 19, wherein the means for controlling the means for switching is configured to drive the coupled inductor power converter subsystem to operate in a substantially zero current switching mode by allowing a magnetizing current developed in the transformer module to drop substantially to zero during each operating cycle of the coupled inductor power converter subsystem.

21. The power converter system of claim 19, wherein the means for controlling the means for switching is configured to drive the coupled inductor power converter subsystem to operate in a substantially zero voltage switching mode by allowing a magnetizing current developed in the transformer module to fall sufficiently below zero during each operating cycle of the coupled inductor power converter subsystem to produce a reversed magnetizing current, such that the reversed magnetizing current is sufficient to drive the means for switching into an ON switching state with substantially zero switching voltage.
